(19) United States
(12) Patent Application Publication
(10) Pub. No.: US 2003/0223111 A1
(43) Pub. Date: Dec. 4, 2003

(54) Sample analysis device having a eucentric goniometer and associated method

(75) Inventors: Michael K. Lamvik, Carrboro, NC (US); Sonia Grego, Carrboro, NC (US); Gary E. McGuire, Carrboro, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: MCNC

(21) Appl. No.: 10/160,992

(22) Filed: May 31, 2002

(51) Int. Cl. G02B 21/00; G02B 21/26

(52) U.S. Cl. 359/394; 359/368; 359/391; 359/393

(57) ABSTRACT

A sample analysis device is provided, the device comprising a frame adapted to accept at least one analysis apparatus, with each analysis apparatus having an analysis distance associated therewith. A eucentric goniometer is operably engaged with the frame and is adapted to eucentrically support a sample at a eucentric point within a reference system defined by the eucentric goniometer. The reference system of the eucentric goniometer is independent of the analysis distance. An axial adjustment device is operably engaged with at least one of the frame and the eucentric goniometer and is configured to coincidentally position the eucentric point and the analysis distance for the respective analysis apparatus. An associated device and method are also provided.

### FEDERALLY SPONSORED RESEARCH OR DEVELOPMENT

This invention was made with Government support under Army Research Office grant number DAA-D19-00-2-0003. The Government may have certain rights to this invention.

### BACKGROUND OF THE INVENTION

1. Field of the Invention

The present invention relates to sample analysis devices and, more particularly, to a sample analysis device employing a eucentric goniometer and configured to interchangeably or concurrently accept any or all of a plurality of analysis apparatuses for analyzing a sample.

2. Description of Related Art

Analysis techniques exist which require an object to be studied, in some instances on a microscopic level, at a variety of angles. For example, a thorough characterization of emission properties of microfabricated emissive, reflective, or optically active devices requires that such devices be analyzed from different angles. Such a requirement is illustrated, for instance, in the analysis of an organic light-emitting diode (OLED) or of a photonic crystal. A photonic crystal has a microscopic structure with preferred directions of transmitting light. One method of fabricating such crystals involves spontaneous assembly of silica or polymer colloids in close-packed arrays of spheres with submicrometer periodicity to provide a “colloid crystal” in the millimeter size range, but with apolycrystalline substructure having sub-100 μm domain sizes. Thus, optical properties of the crystal can be measured using optical probes having spot sizes smaller than the intrinsic domain size. Accordingly, with such small features, a microscope or magnifying objective is used in the set-up procedure.

The angular dependence of the optical properties of such photonic crystals is of primary interest, and these optical properties are studied with, for example, spectrophotometers with variable angle sample holders configured for transmitted illumination. However, the optical measurements using such equipment tend to average over several domains and may undesirably depend on the specific positioning of the sample in the holder, even with magnifying objectives and optical probes having spot sizes smaller than the intrinsic domain size. Further, since such measurements and adjustments to the position of the sample occur on a microscopic level, it may be difficult to ascertain that the same domain is being analyzed at the different angles. One solution to obtaining useful measurement results may be to implement a eucentric goniometer as a sample holder, which supports a sample about a eucentric point. That is, the eucentric point comprises a common point at which the tilt and rotational axes of the sample holder intersect and about which the sample may be tilted without translation.

However, even though the sample holder may be improved with respect to performing a series of angular measurements on the sample, there are still shortcomings to an analysis device configured in such a manner. For example, the goniometer may be configured such that the eucentric adjustment is concurrently performed with the focus adjustment for the analyzing device. In such an instance, the initial adjustment and then subsequent adjustments may be difficult and time-consuming. Further, where the sample must be analyzed by one or more analysis techniques, which may call for various analysis devices, the adjustment shortcomings may become compounded. In addition, the results of the various analyses may not correspond to the same point on the sample. Moreover, in some instances, it may be desirable for more than one analysis technique to be performed concurrently on the same point on the sample. For instance, it may be desirable to capture an image of the sample at the same time an emission measurement of the photonic crystal is made at a particular sample angle.

Thus, there exists a need for an apparatus and method for analyzing samples having an improved and less time-consuming adjustment process for preparing the sample for analysis with an analysis apparatus. More particularly, the adjustment process should preferably be rapid and accurate, with minimal complexity. Such an apparatus and method should preferably be configured to hold the sample in a eucentric condition so as to allow, for example, the sample to be tilted over a range of angles without experiencing translation during the tilting procedure. The apparatus and method should also provide for the capability of analyzing the sample using one or more analysis apparatuses, either separately or concurrently. The apparatus and method should further be capable of receiving each analysis apparatus in such a manner that the respective analysis apparatus is aligned to analyze the same point on the sample so as to facilitate correlations between analysis techniques.

### BRIEF SUMMARY OF THE INVENTION

The above and other needs are met by the present invention which, in one embodiment, provides a sample analysis device comprising a frame adapted to accept at least one analysis apparatus, with each analysis apparatus having an analysis distance associated therewith. A eucentric goniometer is operably engaged with the frame and is adapted to eucentrically support a sample at a eucentric point within a reference system defined by the eucentric goniometer. The reference system of the eucentric goniometer is independent of the analysis distance. An axial adjustment device is operably engaged with at least one of the frame and the eucentric goniometer and is configured to coincidentally position the eucentric point and the analysis distance for the respective analysis apparatus.

Another advantageous aspect of the present invention comprises a sample analysis device having a frame and at least one analysis apparatus operably engaged with the frame, wherein each analysis apparatus has an analysis distance associated therewith. A eucentric goniometer is operably engaged with the frame and is adapted to eucentrically support a sample at a eucentric point within a reference system defined by the eucentric goniometer, wherein the reference system is independent of the analysis distance. An axial adjustment device is operably engaged with at least one of the frame and the eucentric goniometer and is configured to coincidentally position the eucentric point and the analysis distance for the respective analysis apparatus.

Still another advantageous aspect of the present invention comprises a method of analyzing a sample. First, a sample is operably engaged with a eucentric goniometer supported by a frame such that the sample is eucentrically supported at a eucentric point within a reference system defined by the eucentric goniometer. An axial adjustment device is then adjusted so as to coincidentally position the eucentric point and an analysis distance associated with at least one analysis apparatus operably engaged with the frame, wherein the analysis distance is independent of the reference system.

Thus, embodiments of the present invention provide an apparatus and method for analyzing samples having an improved, accurate, minimally-complex, and less time-consuming adjustment process for preparing the sample for analysis with an analysis apparatus. Embodiments of the present invention are further configured to hold the sample in a eucentric condition so as to allow the sample to be tilted over a range of angles and rotated without experiencing translation. Accordingly, an apparatus and method according to the present invention also provides for the capability of analyzing the sample using one or more analysis apparatuses, either separately or concurrently, wherein each analysis apparatus is received in such a manner that the respective analysis apparatus is aligned to analyze the same point on the sample. Therefore, embodiments of the present invention provide distinct advantages as detailed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1-3 are various schematic views of a sample analysis device having a eucentric goniometer according to one embodiment of the present invention.

FIG. 4 is a schematic cross-sectional view of a eucentric goniometer according to one embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

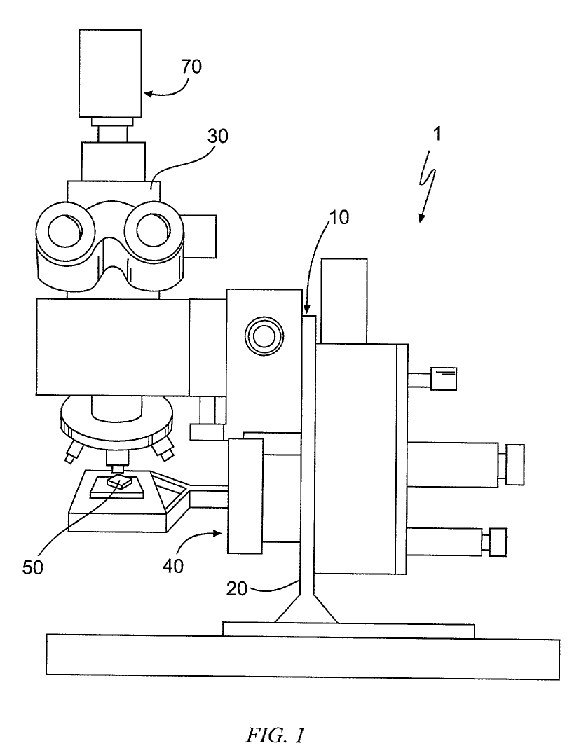

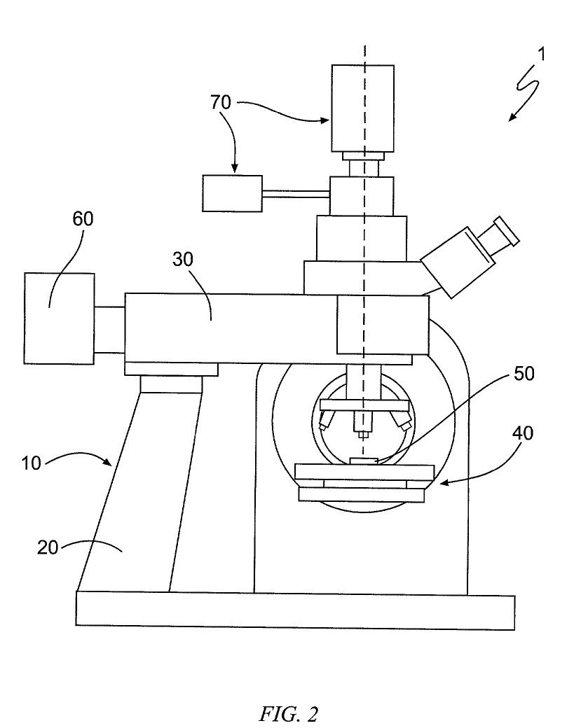

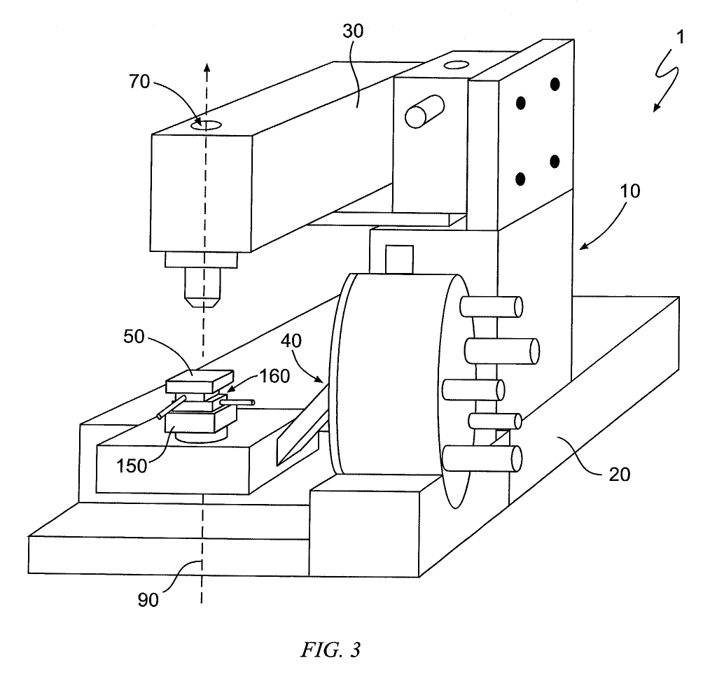

FIGS. 1-3 illustrate a sample analysis device according to one embodiment of the present invention, the device being indicated generally by the numeral 1. The sample analysis device 1 comprises frame 10 having a base portion 20 and an analysis apparatus support portion 30 extending thereabove. The base portion 20 supports a eucentric goniometer 40 (also referred to herein as “goniometer 40”) thereon, wherein the goniometer 40 is described further below. The goniometer 40 is configured to support a sample 50. A light source 60 is disposed on or about the device 10 and is configured so as to suitably illuminate the sample 50. The analysis apparatus support portion 30 is configured to accept one or more analysis apparatuses 70 for analyzing the sample 50.

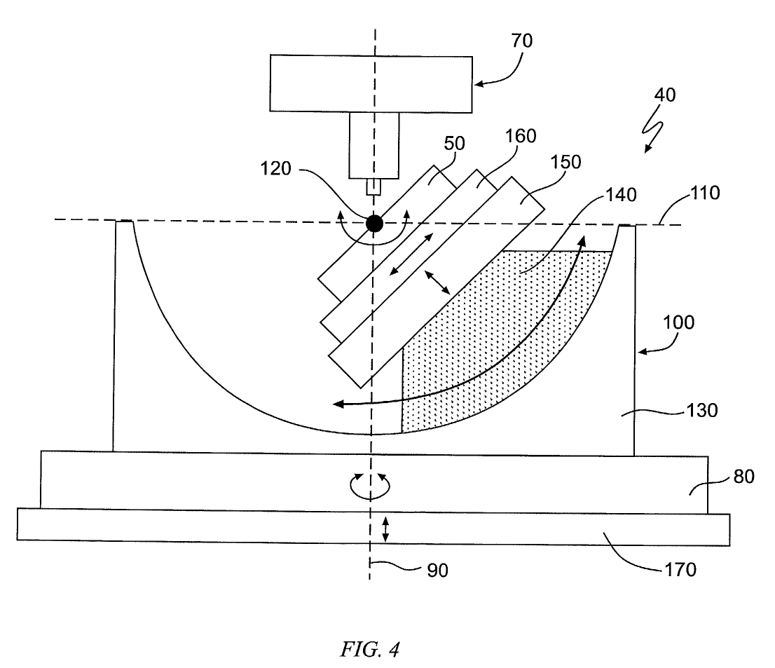

As shown in FIGS. 1-3 and, more particularly in FIG. 4, a goniometer 40 as implemented by embodiments of the present invention comprises a rotational device 80 configured to rotate about a rotational axis 90 extending perpendicularly therethrough. The rotational device 80 supports a tilting device 100 configured to have a tilt axis 110 extending perpendicularly through the rotational axis 90. The intersection of the rotational axis 90 and the tilt axis 110 is referred to herein as the eucentric point 120, or the point about which the sample 50 may be tilted without translation thereof. The eucentric point 120 thus comprises a reference point with respect to an internal reference frame defined by the goniometer 40, which does not vary according to the disposition of the goniometer 40. The tilting device 100 further comprises a base portion 130 and a pivoting portion 140 mounted thereto, wherein movement of the pivoting portion 140 with respect to the base portion causes the pivoting portion 140 to pivot about the tilt axis 110.

The pivoting portion 140 of the tilting device 100 further supports an extension device 150, wherein the extension device 150 further supports a lateral shifting device 160. The lateral shifting device 160 is configured to receive and support the sample 50 thereon, wherein the sample 50 may be, for example, in the form of the raw material being studied or mounted on a microscope slide or other mount. Accordingly, the lateral shifting device 160 provides for lateral movement of the sample 50 with respect to the extension device 150, while the extension device 150 allows a desired point on the sample 50 to be moved to the eucentric point 120 without moving the tilting device 100 or the rotational device 80. That is, the extension device 150 and the lateral shifting device 160 are configured to cooperate to adjust the desired point on the sample 50 to the eucentric point 120 within the internal reference frame of the goniometer 40. Once the desired point on the sample 50 is set at the eucentric point 120, the sample 50 may then be tilted about the tilt axis 110 and/or rotated about the rotational axis 90 without translation of the desired point. In addition, according to one advantageous aspect of the present invention, the described goniometer 40 is capable of manipulating the position and orientation of the sample 50 through a hemispherical space extending from a plane defined through the tilt axis 110 in perpendicular relation to the rotational axis 90. Though one embodiment of a goniometer 40 is shown and described in FIG. 4, and described in relation to the device 1 shown in FIGS. 1-3, one skilled in the art will realize and appreciate that many different forms of eucentric goniometers may also be used with the device 1, wherein such alternate eucentric goniometers are discussed further below.

When incorporated into the device 1, the goniometer 40 is supported by the base portion 20 of the frame 10 such that the rotational axis 90 is perpendicular to the base portion 20. However, according to one particularly advantageous aspect of the present invention, an axial adjustment device 170 is disposed between the goniometer 40 and the base portion 20 for moving the goniometer 40, and thus the desired point on the sample 50, along the rotational axis 90 of the rotational device 80. Accordingly, the eucentric point 120 within the internal reference frame of the goniometer 40 may be moved axially with respect to an external reference frame defined by the device 1 without disturbing the eucentric condition. That is, regardless of the adjustment of the axial disposition of the goniometer 40 imparted by the axial adjustment device 170, the desired point on the sample 50 remains at the eucentric point 120 and, since the eucentric point 120 is defined within an independent reference frame internal to the goniometer 40, may be rotated and tilted thereabout without translation of the desired point.

In order to analyze the sample 50, illumination is typically required. Accordingly, the light source 60 is disposed with respect to the frame 10 and the goniometer 40 to suitably illuminate the sample 50. For example, the light source 60 may be configured so as to provide incident illumination of the sample 50 for reflectivity studies. In such a situation, a relationship between the illumination provided by the light source 60 and the goniometer 40 may be developed such that the angle between the incident illumination and the sample 50 can be determined through the range of motion of the sample 50 about the eucentric point 120 as allowed by the goniometer 40. In other instances, the light source 60 may be configured so as to provide transmitted illumination of the sample 50. In those instances, the light source 60 would provide the necessary illumination through the axial adjustment device 170, as well as the previously described components of the goniometer 40, wherein the implementation of the transmitted illumination scheme will be appreciated by one skilled in the art. For example, each of the axial adjustment device 170 and the components of the goniometer 40 may be provided with cooperating slots or other openings (not shown) therethrough so as to allow the light source 60 to provide the illumination along the rotational axis 90 and through the sample 50. Alternatively, for example, the necessary transmitted illumination may be provided by fiber optics (not shown) extending from the light source 60 to the goniometer 40, with the components of the goniometer 40 being configured to receive the fiber optics and to direct the light emitted therefrom at the sample 50 in the required orientation. One skilled in the art will also appreciate that the light source 60 may be enhanced in many different manners as required by the particular analysis technique. For example, the emitted light from the light source 60 may be selectively polarized or otherwise manipulated for providing the required illumination for the sample 50.

The purpose of the device 1 is to permit analysis of the sample 50, wherein such an analysis may take many forms. However, where it is desired to analyze a sample 50 with more than one analysis technique, it may be very difficult to locate the same point on the sample 50 and to analyze that point under similar conditions of, for example, illumination and the like. Thus, according to embodiments of the present invention, the analysis apparatus support portion 30 of the frame 10 is configured to receive one or more analysis apparatuses 70 in such a manner as to allow each analysis apparatus 70 to analyze the same point on the sample 50, preferably located at the eucentric point 120. Such an analysis apparatus 70 may comprise, for example, a microscope or other magnifying device, an image acquisition device, various photometers, and various spectrometers. Appropriate photometers may be, for example, based on photodiodes or photomultiplier detectors such as, for instance, a Series 6 Low Dark Current Photodiode manufactured by Pacific Silicon Sensor, Inc. of Westlake Village, Calif. or a Model D-104B Microscope Photometer manufactured by Photon Technology International of Lawrenceville, N.J., while suitable spectrometers may comprise, for example, a Model NIR512 Near Infrared Spectrometer or a Model USB2000 Fiber Optic Spectrometer manufactured by Ocean Optics, Inc. of Dunedin, Fla. Each analysis apparatus 70 has an analysis distance external thereto. For example, a microscope or camera will have a lens with an optimal focus distance, whereas, the photometers and spectrometers will also have an optimal analysis distance. One of the purposes of the device 1 according to the present invention is thus to facilitate the correspondence of the analysis distances of the various analysis apparatuses 70 with the eucentric point 120 of the goniometer 40.

According to one advantageous aspect of the present invention, the analysis apparatus support portion 30 of the frame 10 is configured to interchangeably receive a plurality of analysis apparatuses 70. That is, the analysis apparatus 70 operably engaged with the analysis apparatus support portion 30 may be replaced with another analysis apparatus 70 without disturbing the operable engagement between the goniometer 40 and the base portion 20 of the frame 10. In this manner, the desired point on the sample 50 is maintained at the eucentric point 120 and the desired point may thus be analyzed by each of a plurality of analysis apparatuses 70 without requiring time-consuming or inaccurate realignment of the sample 50. More specifically, the analysis apparatus support portion 30 and/or the analysis apparatus 70 may be configured such that, when the analysis apparatus 70 is engaged with the frame 10, the rotational axis 90 of the goniometer 40 is suitably and properly aligned with the analysis apparatus 70. Thus, when the analysis apparatuses 70 are interchanged, analysis of the desired point on the sample 50 may be accomplished by adjusting the axial adjustment device 170 to move the desired point to the analysis distance of the respective analysis apparatus 70 which, as previously described, is external to the reference frame defined by the goniometer 40. However, in some instances, the analysis apparatus support portion 30 and/or the analysis apparatuses 70 may be configured so as to provide corresponding or coinciding analysis distances for the respective analysis apparatuses 70 when installed on the frame 10. In such instances, the axial adjustment device 170 may only need an initial adjustment or a minor subsequent adjustment in order to place the eucentric point 120 at the appropriate analysis distance.

One skilled in the art will appreciate, however, that the device 1 may be configured in many different forms in order to realize the advantages as detailed herein. For example, instead of being configured such that the analysis apparatuses 70 are interchangeable, the analysis apparatus support portion 30 may be configured to concurrently accept a plurality of analysis apparatuses 70. Moreover, the plurality of analysis apparatuses 70 may be incorporated into the analysis apparatus support portion 30 such that the respective analysis distances thereof are in correspondence or coincident. Accordingly, once the eucentric point 120 is placed at the appropriate analysis distance by an initial adjustment of the axial adjustment device 170, each of the analysis apparatuses 70 are able to analyze the desired point on the sample 50 with, if necessary, only minor subsequent adjustments of the axial adjustment device 170.

Many modifications and other embodiments of the inventions set forth herein will come to mind to one skilled in the art to which these inventions pertain having the benefit of the teachings presented in the foregoing descriptions and the associated drawings. For example, the goniometer 40 may be configured such that the rotational device 80 is replaced by a second tilting device, which would support the tilting device 100. In such an instance, similar functionality is provided for the goniometer 40 for maintaining the desired point on the sample 50 at the eucentric point 120. Further, for example, the axial adjustment device 170 may be operably engaged with the frame 10 instead of between the base portion 20 of the frame 10 and the goniometer 40. For instance, the axial adjustment device 170 may be disposed between the analysis apparatus support portion 30 and the base portion 20, whereby axial movement between the goniometer 40 and the analysis apparatus(es) 70 would also be facilitated. In still other instances, the axial adjustment device 170 may be operably engaged between the analysis apparatus(es) 70 and the analysis apparatus support portion 30 of the frame 10, as will be appreciated by one skilled in the art. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A sample analysis device, comprising:
a frame adapted to accept at least one analysis apparatus, each analysis apparatus having an analysis distance associated therewith;
a eucentric goniometer operably engaged with the frame and adapted to eucentrically support a sample at a eucentric point within a reference system defined by the eucentric goniometer, the reference system being independent of the analysis distance; and
an axial adjustment device operably engaged with at least one of the frame and the eucentric goniometer and configured to coincidentally position the eucentric point and the analysis distance for the respective analysis apparatus.

2. A device according to claim 1 wherein the frame is configured to interchangeably accept a plurality of analysis apparatuses.

3. A device according to claim 1 wherein the frame is configured to concurrently accept a plurality of analysis apparatuses.

4. A device according to claim 1 wherein the frame is configured to accept a plurality of analysis apparatuses such that the analysis distances thereof are coincident.

5. A device according to claim 1 wherein the eucentric goniometer further comprises:
a lateral shifting device adapted to accept the sample thereon;
an extension device supporting the lateral shifting device;
a tilting device supporting the extension device; and
a rotational device supporting the tilting device, the lateral shifting device, the extension device, the tilting device and the rotational device cooperating to position a selected point of the sample at the eucentric point within the reference frame.

6. A device according to claim 1 further comprising an illumination device operably engaged with the frame and configured to provide incident illumination of the sample.

7. A device according to claim 1 further comprising an illumination device having a polarization device operably engaged therewith, the illumination device cooperating with the polarization device to provide selectively polarized incident illumination of the sample.

8. A device according to claim 1 further comprising an illumination device operably engaged with at least one of the frame, the axial adjustment device, and the eucentric goniometer and cooperable therewith so as to provide transmitted illumination of the sample.

9. A device according to claim 1 wherein the eucentric goniometer further comprises:
a lateral shifting device adapted to accept the sample thereon;
an extension device supporting the lateral shifting device;
a first tilting device supporting the extension device; and
a second tilting device supporting the first tilting device, the lateral shifting device, the extension device, and the first and second tilting devices cooperating to position a selected point of the sample at the eucentric point within the reference frame.

10. A device according to claim 1 wherein the axial adjustment device is operably engaged with the frame so as to support the eucentric goniometer and is configured to move the eucentric goniometer with respect to the frame so as to position the eucentric point at the analysis distance for the respective analysis apparatus.

11. A device according to claim 1 wherein the axial adjustment device is operably engaged with the frame so as to support the at least one analysis apparatus and is configured to move the at least one analysis apparatus with respect to the frame so as to position the analysis distance for the respective analysis apparatus at the eucentric point of the eucentric goniometer.

12. A sample analysis device, comprising:
a frame;
at least one analysis apparatus operably engaged with the frame, each analysis apparatus having an analysis distance associated therewith;
a eucentric goniometer operably engaged with the frame and adapted to eucentrically support a sample at a eucentric point within a reference system defined by the eucentric goniometer, the reference system being independent of the analysis distance; and
an axial adjustment device operably engaged with at least one of the frame and the eucentric goniometer and configured to coincidentally position the eucentric point and the analysis distance for the respective analysis apparatus.

13. A device according to claim 12 further comprising a plurality of analysis apparatuses, wherein the frame is configured to interchangeably accept each of the plurality of analysis apparatuses.

14. A device according to claim 12 further comprising a plurality of analysis apparatuses, wherein the frame is configured to concurrently accept the plurality of analysis apparatuses.

15. A device according to claim 12 further comprising a plurality of analysis apparatuses, wherein the frame is configured to accept the plurality of analysis apparatuses such that the analysis distances thereof are coincident.

16. A device according to claim 12 wherein the eucentric goniometer further comprises:
a lateral shifting device adapted to accept the sample thereon;
an extension device supporting the lateral shifting device;
a tilting device supporting the extension device; and
a rotational device supporting the tilting device, the lateral shifting device, the extension device, the tilting device and the rotational device cooperating to position a selected point of the sample at the eucentric point within the reference frame.

17. A device according to claim 12 further comprising an illumination device operably engaged with the frame and configured to provide incident illumination of the sample.

18. A device according to claim 12 further comprising an illumination device having a polarization device operably engaged therewith, the illumination device cooperating with the polarization device to provide selectively polarized illumination of the sample.

19. A device according to claim 12 further comprising an illumination device operably engaged with at least one of the frame, the axial adjustment device, and the eucentric goniometer and cooperable therewith so as to provide transmitted illumination of the sample.

20. A device according to claim 12 wherein the eucentric goniometer further comprises:
a lateral shifting device adapted to accept the sample thereon;
an extension device supporting the lateral shifting device;
a first tilting device supporting the extension device; and
a second tilting device supporting the first tilting device, the lateral shifting device, the extension device, and the first and second tilting devices cooperating to position a selected point of the sample at the eucentric point within the reference frame.

21. A device according to claim 12 wherein the axial adjustment device is operably engaged with the frame so as to support the eucentric goniometer and is configured to move the eucentric goniometer with respect to the frame so as to position the eucentric point at the analysis distance for the respective analysis apparatus.

22. A device according to claim 12 wherein the axial adjustment device is operably engaged with the frame so as to support the at least one analysis apparatus and is configured to move the at least one analysis apparatus with respect to the frame so as to position the analysis distance for the respective analysis apparatus at the eucentric point of the eucentric goniometer.

23. A method of analyzing a sample, comprising:
operably engaging a sample with a eucentric goniometer supported by a frame such that the sample is eucentrically supported at a eucentric point within a reference system defined by the eucentric goniometer; and
adjusting an axial adjustment device so as to coincidentally position the eucentric point and an analysis distance associated with at least one analysis apparatus operably engaged with the frame, the analysis distance being independent of the reference system.

24. A method according to claim 23 wherein adjusting an axial adjustment device further comprises adjusting an axial adjustment device, operably engaged with the frame and supporting the at least one analysis apparatus, so as to move the at least one analysis apparatus with respect to the frame and to position the analysis distance for the respective analysis apparatus at the eucentric point of the eucentric goniometer.

25. A method according to claim 23 wherein adjusting an axial adjustment device further comprises adjusting an axial adjustment device, operably engaged with the frame and supporting the eucentric goniometer, so as to move the eucentric goniometer with respect to the frame and to position the eucentric point of the eucentric goniometer at the analysis distance for the respective analysis apparatus.

26. A method according to claim 23 further comprising illuminating the sample with an illumination device operably engaged with the frame and configured to provide incident illumination.

27. A method according to claim 23 further comprising illuminating the sample with an illumination device having a polarization device operably engaged therewith, the illumination device cooperating with the polarization device to provide selectively polarized illumination.

28. A method according to claim 23 further comprising illuminating the sample with an illumination device operably engaged with at least one of the frame, the axial adjustment device, and the eucentric goniometer and cooperable therewith so as to provide transmitted illumination.

29. A method according to claim 23 wherein adjusting an axial adjustment device further comprises adjusting an axial adjustment device so as to coincidentally position the eucentric point and an analysis distance associated with a respective analysis apparatus of a plurality of analysis apparatuses interchangeably acceptable by the frame.

30. A method according to claim 23 wherein adjusting an axial adjustment device further comprises adjusting an axial adjustment device so as to coincidentally position the eucentric point and an analysis distance associated with a respective analysis apparatus of a plurality of analysis apparatuses concurrently acceptable by the frame.

31. A method according to claim 23 wherein adjusting an axial adjustment device further comprises adjusting an axial adjustment device so as to coincidentally position the eucentric point and a common analysis distance associated with a plurality of analysis apparatuses acceptable by the frame.

32. A method according to claim 23 wherein operably engaging a sample with a eucentric goniometer further comprises operably engaging a sample with a eucentric goniometer comprising:
a lateral shifting device adapted to accept the sample thereon;
an extension device supporting the lateral shifting device;
a tilting device supporting the extension device; and
a rotational device supporting the tilting device, the lateral shifting device, the extension device, the tilting device and the rotational device cooperating to position a selected point of the sample at the eucentric point within the reference frame.

33. A method according to claim 23 wherein operably engaging a sample with a eucentric goniometer further comprises operably engaging a sample with a eucentric goniometer comprising:
a lateral shifting device adapted to accept the sample thereon;
an extension device supporting the lateral shifting device;
a first tilting device supporting the extension device; and
a second tilting device supporting the first tilting device, the lateral shifting device, the extension device, and the first and second tilting devices cooperating to position a selected point of the sample at the eucentric point within the reference frame.
